(19) United States
(12) Patent Application Publication
(10) Pub. No.: US 2008/0151835 A1
(43) Pub. Date: Jun. 26, 2008

(54) Controlling Change of an Access Point in a Communication System

(75) Inventors: Jarkko Kneckt, Espoo (FI); Jari Jokela, Ylojarvi (FI)

Correspondence Address: SQUIRE, SANDERS & DEMPSEY L.L.P., 8000 TOWERS CRESCENT DRIVE, 14TH FLOOR, VIENNA, VA, 22182-2700, US

(73) Assignee: NOKIA CORPORATION, Espoo (FI)

(21) Appl. No.: 11/663,423

(22) PCT Filed: Sep. 20, 2004
(86) PCT No.: PCT/FI04/00553

§ 371 Date: May 31, 2007

(51) Int. Cl. H04Q 7/20

(52) U.S. Cl. 370/331

(57) ABSTRACT

A method provides controlling change of an access point in a communication system. The method comprises receiving, in a terminal having an ongoing connection with a first access point, delivery information relating to an amount of data to be delivered from the first access point. The method also comprises controlling change from the first access point to a second access point based on the delivery information. Furthermore, an access point for a communication system and a terminal for accessing a communication system are provided configured to execute the method.

### FIELD OF THE INVENTION

The invention relates to communication systems, and more particularly to controlling change of an access point in a communication system, in particular in a wireless communication system.

### BACKGROUND OF THE INVENTION

A communication system can be seen as a facility that enables communications between two or more entities, also called stations. Examples of stations may comprise, but are not limited to, a communication device or terminal, e.g. mobile stations (MS) or user equipment (UE), and/or other network elements, also called nodes, e.g. Node B or base transceiver station (BTS) or an access point (AP), and so on, associated with the communication system. A communication system typically operates in accordance with a given standard or specification which sets out what the various entities associated with the communication system are permitted to do and how that should be achieved. A station typically has an address for enabling transmission of data to a correct entity. Different addressing schemes may be used in different communication systems.

Examples of communication systems may include, but are not limited to, wireless communication systems, such as a public land mobile network (PLMN), e.g. the global system for mobile communications (GSM), the general packet radio service (GPRS) and the third generation (3G) mobile communication systems, such as the universal mobile telecommunications system (UMTS). Furthermore, communication systems may comprise local area network (LAN) or wireless LAN (WLAN), such as the Ethernet. Communication systems may also comprise an Internet protocol (IP) transport network and other packet switched data networks, and so on. Various communication systems may simultaneously be concerned in a connection. A user may access a communication system using an appropriate communication device, also called terminal. Examples of communication devices may comprises, but are not limited to, user equipment (UE), a mobile station (MS), a cellular phone, a personal digital assistant (PDA) or the like, or other devices, such as a personal computer (PC).

The OSI (Open Systems Interconnection) model divides functions of a communication system into seven layers, each layer providing defined services to a next upper layer. For example, layer 2 provides services with layer 3 while layer 3 provides services with layer 4. Layer 2 of the OSI model is also referred to as the Data Link Layer (DLL). The purpose of the DLL is to synchronise data bit streams flowing to and from the Layer 1 of the OSI model, also called the Physical Layer. Furthermore, detection of transmission errors, such as noise and interference, is also provided by the DLL. The DLL is divided into two sub-layers, upper of which is called Link Access Control (LAC) and lower Medium Access Control (MAC). The MAC is used for handling access to a shared medium in various technologies, such as the GPRS, UMTS and Ethernet.

The medium access control (MAC) and physical characteristics for wireless local area networks (LANs) are specified in the standard IEEE Std 802.11®-1999 (Reaff 2003), Information technology—Telecommunications and information exchange between systems—Local and metropolitan area networks—Specific requirements—Part 11: Wireless LAN Medium Access Control (MAC) and Physical Layer (PHY) Specifications. Paragraph 7 of said standard specifies the format of MAC frames or MAC protocol data units, which are constructed by stations for transmission and decoded by stations upon reception. According to the standard, each frame consists of a MAC header, a variable length frame body and a frame check sequence (FCS) as a set of fields that occur in a fixed order in all frames. The MAC header comprises frame control, duration, address and sequence control information. The frame control field of the MAC header consists of the following sub-fields: Protocol Version, Type, Subtype, To DS, From DS, More Fragments, Retry, Power Management, More Data, WEP, and Order.

An access point (AP) in a communication system, for example in a wireless network, may provide access via a wireless medium, such as a radio interface, to distribution of services provided by the communication system from the same wireless network or from a different network, such as from the Internet. When data traffic from said network arrives to an AP, the AP delivers the data to the terminal as soon as possible. An AP may provide storing capacity for buffering data to be delivered. Buffering means that an amount of data traffic may wait, in the access point, for an opportunity to transmit the data traffic to the terminal. When the terminal is available for receiving data, the buffered data is transmitted to the terminal in a predefined order.

In accordance with the IEEE Std 802.11®-1999 (Reaff 2003), paragraph 7.1.3.1.8, for terminals that use power save, the more data bit in the frame control field of the MAC header is used to give information whether an AP has buffered data for the power save terminal. The power save terminals having no real time ongoing data streams are listening only periodically beacon frames, for example, in order to receive information if an AP has any traffic to be delivered to the terminal. Information indicating that the terminal has buffered data is different in a beacon frame than in a normal data (directed) frame. In the beacon frame, the AP uses a traffic indication map (TIM) field to indicate buffered data while in the data frames a more data-bit is used. For terminals that do not use power save, the more data information is not given, because the non-power save terminals are listening the media all the time.

The IEEE Std 802.11®-1999 (Reaff 2003), paragraph 7.1.3.1.7 defines the power management field which indicates the power management mode of a non-AP station, such as a terminal. In accordance with this standard, a value of 1 of this one bit power management field indicates that the station will be in a power save (PS) mode after a successful completion of a frame exchange sequence. Respectively, a value 0 indicates that the station will be in an active mode.

Enhanced quality of service (QoS) and power save schemes are specified in IEEE P802.11e/D8.0, February 2004, (Draft Amendment to IEEE Std 802.11, 1999 Edition (Reaff 2003)). The 802.11e standard modifies the use of the more data bit in respect of the QoS. However, the definition of using the more data bit only for power save terminals remains.

### SUMMARY OF THE INVENTION

The present invention proposes embodiments where the more data bit may be used for all terminals regardless of the power management mode of the terminal. In accordance with embodiments of the invention, terminals in a full power mode may receive the more data bit information as well as terminals in a power save mode.

In accordance with an aspect of the invention, there is provided a method for controlling change of an access point in a communication system. The method comprises receiving, in a terminal having an ongoing connection with a first access point, delivery information relating to an amount of data to be delivered from the first access point. Furthermore, the method comprises controlling change from the first access point to a second access point based on the delivery information.

In accordance with another aspect of the invention, there is provided an access point for a communication system configured to provide delivery information relating to an amount of data to be delivered from the access point to a terminal having an ongoing connection with the access point.

In accordance with another aspect of the invention, there is provided a terminal for accessing a communication system configured to decide, based on delivery information relating to an amount of data to be delivered from a first access point to the terminal having an ongoing connection with the first access point, whether the terminal delays a change from the first access point to a second access point until the delivery information indicates that no data units to be delivered to the terminal is present in the first access point.

In an embodiment, the delivery information may comprise receiving a more data bit in a frame control field of a medium access control frame. The more data bit may be set to one indicating that at least one data unit remains in the first access point to be delivered to the terminal. The more data bit may be set to zero indicating that no data units is present in the first access point to be delivered to the terminal. The more data bit may indicate an access category of the data to be delivered.

In an embodiment, it may be decided whether the terminal delays the change of the access point until the delivery information indicates that no data units to be delivered to the terminal is present in the first access point.

In accordance with another aspect of the invention, there is provided a method for providing information in a communication system, the method comprising providing a terminal with delivery information relating to an amount of data to be delivered from a first access point, regardless of the power management mode of the terminal.

In accordance with another aspect of the invention, there is provided an access point for a communication system configured to provide delivery information relating to an amount of data to be delivered from the access point to a terminal regardless of a power management mode of the terminal.

In accordance with another aspect of the invention, there is provided a terminal for accessing a communication system configured to interpret delivery information relating to an amount of data to be delivered from the access point to a terminal regardless of a power management mode of the terminal.

In an embodiment, the delivery information may comprise providing a more data bit in a frame control field of a medium access control frame to a terminal capable of receiving data at any time in accordance with the similar rules than to a terminal in a power save mode. The more data bit may comprise providing the more data bit set to one indicating that at least one data unit remains in the first access point to be delivered to the terminal. The more data bit may comprise receiving the more data bit set to zero indicating that no data units is present in the first access point to be delivered to the terminal. The more data bit may indicate an access category of the data to be delivered.

In accordance to further aspect of the invention, a communication system comprising an access point as defined above is also provided. Furthermore, a communication system configured to execute the method as described above is provided.

### BRIEF DESCRIPTION OF FIGURES

The invention will now be described in further detail, by way of example only, with reference to the following examples and accompanying drawings, in which:

FIG. 1 shows an exemplifying architecture of a system in which the embodiments of the invention may be implemented;

FIG. 2 shows schematically the MAC frame format as defined in the IEEE Std 802.11®-1999 (Reaff 2003), paragraph 7.1.2;

FIG. 3 shows schematically the frame control field as defined in the IEEE Std 802.11®-1999 (Reaff 2003), paragraph 7.1.3.1; and

FIG. 4 shows a flow chart illustrating an embodiment of the invention.

### DETAILED DESCRIPTION OF THE PREFERRED EMBODIMENTS

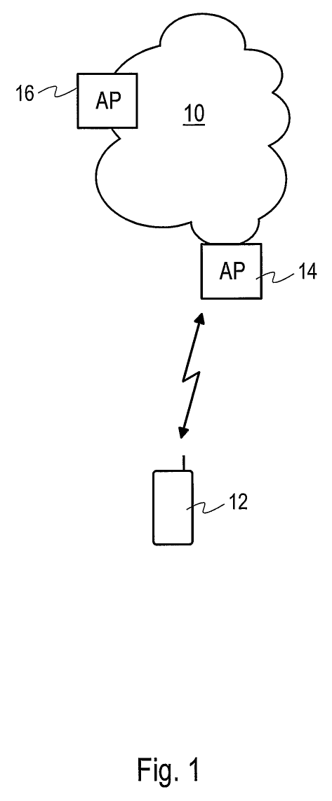

FIG. 1 shows an exemplifying architecture of a system in which the embodiments of the invention may be implemented. A terminal 12 may access a communication network 10 via a first access point (AP) 14. A second access point 16 is also shown. The terminal 12 may use the second access point 16 for accessing the communication network 10, for example, when the terminal 12 moves to an area served by the second access point 16.

It shall be appreciated that FIG. 1 is only an example of a simplified communication system showing only one terminal and two access points. Typically, plenty of communication devices, also called herein terminals or non-access point stations (non-AP STAs), are simultaneously communicating via a communication network. The communication network 10 may comprise any appropriate communication network or networks. In an embodiment, the communication network 10 may be provided at least in part by an IP network, such as the Internet. Furthermore, even if omitted from FIG. 1, a communication system typically comprises various further switching and other control entities and gateways for enabling the communication via a number of access networks and also for interfacing a single communication system with one or more communication systems.

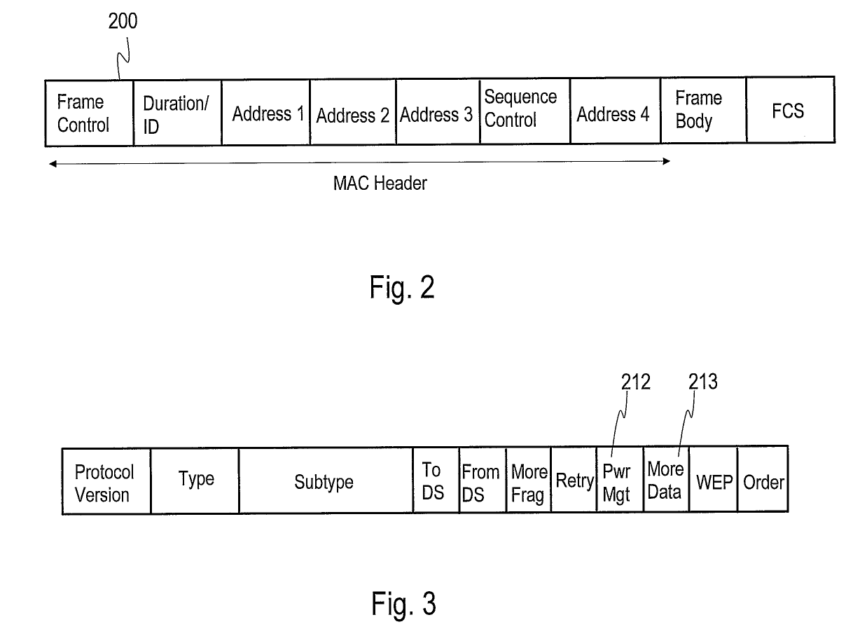

FIG. 2 shows schematically the MAC frame format as defined in the IEEE Std 802.11®-1999 (Reaff 2003), paragraph 7.1.2. The first of the fixed order fields is the frame control field 200, as was explained above and as shown in FIG. 2.

FIG. 3 shows schematically the frame control field 200 of FIG. 2, as defined in the IEEE Std 802.11®-1999 (Reaff 2003), paragraph 7.1.3.1. The invention relates to the more data bit, which is referred to by numeral 213 in FIG. 3. The more data field is one bit in length and is used to indicate to a station in power save mode that more MAC service data units (MSDU) or MAC management protocol data units (MMPDU) are buffered for the station in question in an AP. The power management mode, i.e. power save or active mode, of the terminal is indicated in the power management bit 212. As defined in the IEEE Std 802.11®-1999 (Reaff 2003), paragraph 11.2.1.1, in the active mode, the terminal is all the time in an awake state. In the power save mode, the terminal may be both in a doze state and in the awake state. In the doze state, the terminal is not able to transmit or receive any traffic and the receiver part of the terminal may be switched off. In the awake state the terminal listens the media and is able to receive frames. In the power save mode, the terminal switches to the awake state for listening selected beacon frames.

In accordance with the IEEE Std 802.11®-1999 (Reaff 2003), paragraph 7.1.3.1.8, the more data field is valid in directed data or management type frames transmitted by an AP to a station in power save mode. A value of 1 (one) indicates that at least one additional buffered MSDU or MMPDU is present for the same station. The more data field may be set to 1 in directed data type frames transmitted by a contention free (CF) pollable station to the point coordinator in response to a CF Poll signal to indicate that the station has at least one additional buffered MSDU available for transmission in response to a subsequent CF-Poll. The more data field is set to 0 (zero) in all other directed frames in accordance with the IEEE Std 802.11®-1999 (Reaff 2003), paragraph 7.1.3.1.8. Furthermore, the more data field is set to 1 in broadcast/multicast frames transmitted by the AP when additional broadcast/multicast MSDUs or MMPDUs remain to be transmitted by the AP during the same beacon interval. The more data field is set to 0 in broadcast/multicast frames transmitted by the AP when no more broadcast/multicast MSDUs or MMPDUs remain to be transmitted by the AP during the same beacon interval and in all broadcast/multicast frames transmitted by non-AP stations.

The IEEE P802.11e/D8.0, paragraph 6.1.1.3, defines access categories derived from user priorities. Furthermore, the IEEE P802.11e/D8.0, paragraph 7.1.3.1.8, adds that for a non-AP QoS station (QSTA) that has the “More Data Ack” subfield set in its QoS capability information element and also has automatic power-save delivery (APSD) enabled, a QoS access point (QAP) may set the more data field to 1 in ACK frames to this non-AP QSTA to indicate that the QAP has a pending transmission for the non-AP QSTA.

The IEEE P802.11e/D9.0, August 2004, (Amendment to ANSI/IEEE Std 802.11-1999 (Reaff 2003) edition as amended by IEEE Std 802.11g-2003, IEEE Stad 802.11h-2003 and IEEE 902.11i-2004), see e.g. paragraphs 11.2.1.4 and 11.2.1.5, includes three different power save mechanisms, namely legacy based on PS-POLL frames, unscheduled APSD (U-APSD) and scheduled APSD (S-APSD). One access category may use only one type of power save mechanism. The rules for use of the more data bit depend on the legacy and U-APSD use.

The PS-POLL frames are sent by a terminal, which is not CF pollable and is operating in a power save mode, to the AP when the terminal receives information, in a traffic indication map (TIM) of a beacon signal, that there are buffered units in the AP for the terminal. The terminal remains in the awake state for receiving data units. The AP may send the data units immediately or later. After the more data bit of the data units indicate that the terminal has received all the data units, the terminal may return to the doze state. A CF pollable terminal is informed in the TIM of a beacon frame that there shall be data unit to be delivered during a CF period. The CF pollable terminal remains in the awake state during the CF period.

The U-APSD and S-APSD are delivery mechanisms for the delivery of downlink frames to power-saving stations. In the U-APSD, frames may be delivered during an unscheduled service period and, respectively, in the S-APSD, frames may be delivered during a scheduled service period. The scheduled service periods start at fixed intervals of time and the unscheduled service periods start when triggered by terminals.

If all the access categories use the APSD, the more data bit and the TIM bit are set when the respective AP has traffic, i.e. data bits, buffered for the terminal. If the legacy PS-POLL based power save is used for one or more access categories, the more data bit and the TIM bit are set when the respective AP has traffic buffered in the legacy PS-POLL access categories. Buffered traffic in APSD buffers of the AP is not shown in the more data bit when the legacy PS-POLL based power save is used for one or more access categories.

A terminal may have to or want to make a transition from one access point (AP) to another, for example, in a handover or roaming situation or for another reason. When a transition from a first AP to a second AP is performed, the buffered data, which is waiting for transmission opportunity to the terminal in the first AP, may be delivered to the second AP.

In accordance with embodiments of the invention, the terminal as well in an active mode as in a power save mode may receive information that there is buffered data for the terminal in the first AP. As was defined above, the terminal in the active mode is listening the media all the time and is able to receive frames at any time. Said information of buffered data is preferably received before the terminal changes to the second AP. In embodiments of the invention, the more data can be extended to cover all the different access categories (AC) specified in the IEEE P802.11e, paragraph 6.1.1.3.

In embodiments of the invention, rules for use of the more data bit 213 may be the same for active terminals and power save terminals. Thus, regardless of the status of the power management bit 212, the more data bit 213 may indicate, in embodiments of the invention, whether an AP has buffered data for a terminal. Furthermore, the mechanism used for the power save makes no difference either.

According to an embodiment, with the more data bit information, a terminal 12 intending to change from a first access point 14 to a second access point 14 may first receive all buffered data frames from the first AP 14 and then transit to the second AP 16. This may decrease data delays and erasure ratios. In an embodiment, a terminal, or a user or a client of a terminal, may be given an opportunity to select whether it wants or needs to receive all the data from the first AP before changing to the second AP. If the terminal selects not to receive all the data from the first AP, the terminal may indicate to the first AP that the remaining data should be sent to the second AP and delivered to the terminal via the second AP.

An access point is aware of the state of buffers in the AP for all terminals served by the AP. The AP may keep a record of buffered data. In embodiments of the invention, the AP may provide information on buffered data to the respective terminals regardless of the power management mode of the terminals. The terminals in an active mode may use the information of the buffered data, or “more data” information, similarly as in a power save mode.

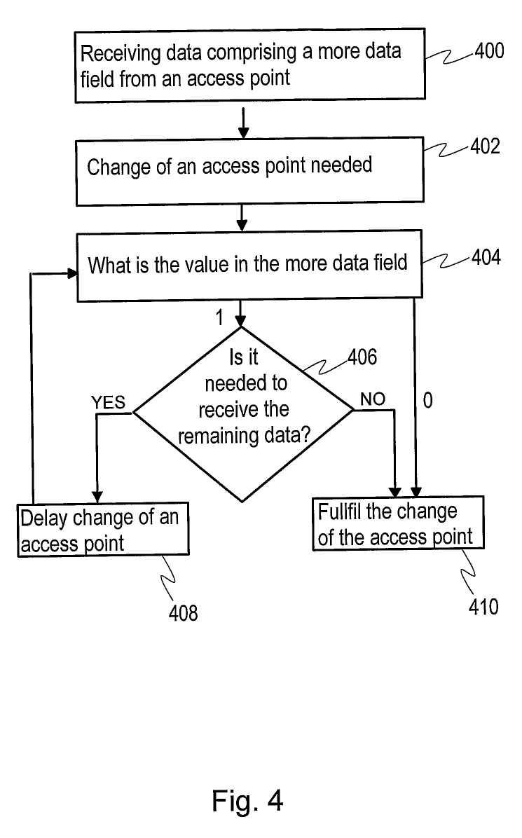

FIG. 4 shows a flow chart illustrating an embodiment of the invention. In step 400, a terminal receives data from a first access point. The data comprises a medium access control (MAC) frame comprising a more data field of a frame control field in the MAC header. The more data field is set to 1 when the first access point still has data to be delivered to the terminal. The more data field is set to 0 when no more data to be delivered to the terminal remains in the first access point. In step 402, the terminal determines a need for a change of an access point, for example a need for a handover to a second access point. In step 404, the terminal verifies what is the value set in the more data field.

If the value is found in step 404 to be set to 1, the terminal verifies, in step 406, whether the remaining data needs to be received. If the terminal finds that the remaining data needs to be received, the terminal delays the change of the access point, in step 408. Steps 404, 406 and 408 may be repeated until the more data field is set to zero.

If the terminal finds, in step 406, that the remaining data does not need to be received or if the value is found, in step 404, to be set to 0, the terminal may proceed, in step 410, with the change of an access point, such as the handover, in an appropriate manner.

In access point changing situations, the connection between the terminal and the first access point may be very poor. It may happen that the connection to the first access point is lost and the terminal hears only the second AP. If the first access point determines that the connection to the terminal is lost, the first access point may send the remaining data to the second access point to be delivered to the terminal via the second access point.

In an embodiment, the more data field can be extended to cover all the access categories (AC) as defined in the IEEE P802.11e standard. Currently, four ACs are defined. The more data field may indicate which AC the buffered frames belong to. This may give more flexibility to terminal algorithm implementation.

Information provided by the more data bit may also be useful in a normal operation as a terminal may be able to control power save states of the terminal based on the more data information.

Embodiments of the invention enable a terminal also in full power operating mode to know that an AP has buffered data for the terminal. The terminal may be able to select a moment for buffered data transition from the AP.

Although the invention has been described in the context of particular embodiments, various modifications are possible without departing from the scope and spirit of the invention as defined by the appended claims. For example, the communication system wherein the invention may be implemented may be any communication system in which an access point may store or buffer traffic to be delivered.

1. A method for controlling change of an access point in a communication system, the method comprising:
receiving, in a communication device having an ongoing connection with a first access point, delivery information relating to an amount of data to be delivered from the first access point; and
controlling change from the first access point to a second access point based on the delivery information.

2. A method according to claim 1, wherein the step of receiving the delivery information comprises receiving a more data bit in a frame control field of a medium access control frame.

3. A method according to claim 2, wherein the step of receiving the more data bit comprises receiving the more data bit set to one indicating that at least one data unit remains in the first access point to be delivered to the communication device.

4. A method according to claim 2, wherein the step of receiving the more data bit comprises receiving the more data bit set to zero indicating that no data units is present in the first access point to be delivered to the communication device.

5. A method according to claim 2, wherein the step of receiving the more data bit comprises receiving the more data bit indicating an access category of the data to be delivered.

6. A method according to claim 1, wherein the step of controlling the change comprises deciding whether the communication device delays the change of the access point until the delivery information indicates that no data units to be delivered to the communication device is present in the first access point.

7. A method according to claim 1, comprising providing a communication device with delivery information relating to an amount of data to be delivered from a first access point, regardless of the power management mode of the communication device.

8. A method according to claim 7, wherein the step of providing the communication device with the delivery information comprises providing a more data bit in a frame control field of a medium access control frame to a communication device capable of receiving data at any time in accordance with similar rules to a communication device in a power save mode.

9. A method according to claim 8, wherein the step of providing with the more data bit comprises providing the more data bit set to one indicating that at least one data unit remains in the first access point to be delivered to the communication device.

10. A method according to claim 8, wherein the step of receiving the more data bit comprises receiving the more data bit set to zero indicating that no data units is present in the first access point to be delivered to the communication device.

11. A method according to claim 8, wherein the step of providing with the more data bit comprises providing the more data bit indicating an access category of the data to be delivered.

12. A computer program comprising program code means for performing any of the steps according to claim 1 when the program is run on a computing means.

13. An access point for a communication system configured to provide delivery information relating to an amount of data to be delivered from the access point to a communication device having an ongoing connection with the access point and to, when a transition of the communication device to another access point is performed, deliver that data to the other access point.

14. An access point according to claim 13, wherein the delivery information comprises a more data bit in a frame control field of a medium access control frame.

15. An access point according to claim 14, wherein the more data bit set to one indicates that at least one data unit remains in the first access point to be delivered to the communication device.

16. An access point according to claim 14, wherein the more data bit set to zero indicates that no data units is present in the first access point to be delivered to the communication device.

17. An access point according to claim 14, wherein the more data bit indicates an access category of the data to be delivered.

18. An access point according to claim 13, the access point being configured to provide the delivery information communication device regardless of a power management mode of the communication device.

19. An access point according to claim 13, the access point being configured to provide a more data bit in a frame control field of a medium access control frame to a communication device capable of receiving data at any time in accordance with similar rules to a communication device in a power save mode.

20. An access point for a communication system comprising means for providing delivery information relating to an amount of data to be delivered from the access point to a communication device having an ongoing connection with the access point and means for, when a transition of the communication device to another access point is performed, delivering that data to the other access point.

21. A communication device for accessing a communication system configured to control, based on delivery information relating to an amount of data to be delivered from a first access point to the communication device having an ongoing connection with the first access point, a change from the first access point to a second access point.

22. A communication device according claim 21, wherein the communication device is configured to control the change from the first access point to the second access point by deciding whether to delay the change of the access point until the delivery information indicates that no data units to be delivered to the communication device are present in the first access point.

23. A communication device according to claim 21, the communication device being configured to interpret the delivery information regardless of a power management mode of the communication device.

24. A communication device for accessing a communication system comprising means for controlling, based on delivery information relating to an amount of data to be delivered from a first access point to the communication device having an ongoing connection with the first access point, a change from the first access point to a second access point.

25. A communication system comprising an access point and a communication device having an ongoing connection with the access point, the access point being configured to provide delivery information relating to an amount of data to be delivered from the access point to the communication device and the communication device being configured to control, based on the delivery information, a change from the first access point to a second access point.

26. A communication system as claimed in claim 25, wherein the communication device is configured to control the change from the first access point to the second access point by deciding whether to delay the change of the access point until the delivery information indicates that no data units to be delivered to the communication device are present in the first access point.

27. A communication system according to claim 25, the access point being configured to provide the delivery information regardless of a power management mode of the communication device.

28. An communication system according to claim 25, the access point being configured to provide a more data bit in a frame control field of a medium access control frame to a communication device capable of receiving data at any time in accordance with similar rules to a communication device in a power save mode.

29. A communication system according to claim 25, the communication device being configured to interpret the delivery information regardless of the power management mode of the communication device.

30. A communication system comprising an access point and a communication device having an ongoing connection with the access point, the access point comprising means for providing delivery information relating to an amount of data to be delivered from the access point to the communication device and the communication device comprising means for controlling, based on the delivery information, a change from the first access point to a second access point.

31. A method comprising providing a communication device with delivery information relating to an amount of data to be delivered from a first access point regardless of the power management mode of said communication device, wherein providing delivery information comprises providing a more data bit in a frame control field of a medium access control frame to said communication device, a value of 1 indicating that at least one additional buffered MSDU or MMPDU is present for the station at the first access point.
